(19) United States
(12) Patent Application Publication
(10) Pub. No.: US 2011/0290672 A1
(43) Pub. Date: Dec. 1, 2011

(54) ELECTROCHEMICAL GAS SENSOR

(75) Inventors: Frank METT, Lubeck (DE); Sabrina SOMMER, Lubeck (DE); Christoph BERNSTEIN, Lubeck (DE); Kerstin LICHTENFELDT, Timmendorfer Strand (DE)

(73) Assignee: Drager Safety AG & Co. KGaA, Lubeck (DE)

(21) Appl. No.: 13/048,134

(22) Filed: Mar. 15, 2011

(30) Foreign Application Priority Data
May 28, 2010 (DE) 10 2010 021 977.0

(51) Int. Cl. G01N 27/30; B82Y 99/00

(52) U.S. Cl. 205/781; 204/431; 204/432; 205/785.5; 205/782.5; 977/750; 977/752; 977/902

(57) ABSTRACT

An electrochemical gas sensor for detecting ozone or nitrogen dioxide in a gas sample has a measuring electrode (3) formed of carbon nanotubes (CNT) or a counterelectrode (8) in an electrolyte solution (9), which contains lithium chloride or lithium bromide in an aqueous solution.

### CROSS REFERENCE TO RELATED APPLICATIONS

This application claims the benefit of priority under 35 U.S.C. §119 of German Patent Application DE 10 2010 021 977.0 filed May 28, 2010, the entire contents of which are incorporated herein by reference.

### FIELD OF THE INVENTION

The present invention pertains to an electrochemical gas sensor for detecting ozone or nitrogen dioxide.

### BACKGROUND OF THE INVENTION

A gas sensor for determining SO₂ or H₂S, which contains a measuring electrode, which has carbon nanotubes, is known from DE 10 2006 014 713 B3. The electrolyte contains a mediator compound based on transition metal salts, with which selective determination of the desired gas component is possible.

The mediator compounds are compounds that have at least one more group, selected from among hydroxyl and acid groups, besides at least one acid group. The mediator compound is, in particular, a carboxylic acid salt, which has, besides the carboxylic acid group, at least one hydroxyl group, preferably at least two hydroxyl groups, and/or at least one more carboxylic acid group. Suitable compounds are also tetraborates, such as sodium tetraborate or lithium tetraborate. Transition metal salts, especially Cu salts, of such mediators make possible the selective determination of SO₂.

A measuring device described in US 2005/0230 270 A1 contains a microelectrode array consisting of carbon nanotubes to detect substances in liquid or gaseous samples.

### SUMMARY OF THE INVENTION

The basic object of the present invention is to provide a gas sensor for detecting ozone or nitrogen dioxide.

According to the invention, an electrochemical gas sensor is provided for detecting ozone or nitrogen dioxide in a gas sample. The electrochemical gas sensor has a measuring electrode containing carbon nanotubes and a counterelectrode in an electrolyte solution. The electrolyte solution has lithium chloride or lithium bromide.

According to another aspect of the invention, a method of electrochemical gas sensing is provided. The method comprises providing an electrochemical gas sensor with a measuring electrode formed of carbon nanotubes (CNT) an electrolyte, which contains lithium chloride or lithium bromide in an aqueous solution and a counterelectrode. The measuring electrode and the counterelectrode are in contact with the electrolyte. The method further comprises detecting ozone or nitrogen dioxide with the electrochemical gas sensor.

It was surprisingly found that the gases ozone and nitrogen dioxide can be detected at a high sensitivity with a measuring electrode consisting of carbon nanotubes (CNT) combined with an aqueous electrolyte, which contains lithium chloride or lithium bromide, while changes in temperature and humidity have only a minor effect on the measured signal.

The reaction equations are:

O₃+2e⁻+2H⁺→O₂+H₂O

NO₂+2e⁻+2H⁺→NO+H₂O.

Measuring electrodes manufactured from carbon nanotubes (CNT) are stable over a long time and can be integrated in existing sensor constructions in a simple manner. Carbon nanotubes are structurally related to the fullerenes, which can be prepared, e.g., by evaporating carbon according to a laser evaporation method. A single-walled carbon nanotube has, for example, a diameter of about one nm and a length of about a thousand nm. Besides single-walled carbon nanotubes, double-walled carbon nanotubes (DW CNT) and structures having multiple walls (MW CNT) are known as well. The layer thickness of the electrode material in the finished electrode is in a range of 0.5 μm to 500 μm and preferably 10-50 μm in measuring electrodes made of carbon nanotubes (CNT).

A measuring electrode manufactured from multiwall carbon nanotubes (MW CNT) yields especially good results.

Due to their manufacture, carbon nanotubes are provided with metal atoms, e.g., Fe, Ni, Co, including the oxides thereof, so that such carbon nanotubes on measuring electrodes possess catalytic activities. It proved to be advantageous to remove these metal particles by acid treatment.

The carbon nanotubes are advantageously applied to a porous carrier, a nonwoven material or a diffusion membrane. The carbon nanotubes are fitted together here by self-aggregation or with a binder. PTFE powder is preferably used as the binder.

It is especially advantageous to manufacture the carbon nanotubes from a prefabricated film, a so-called “buckypaper.” The measuring electrode can then be punched directly out of the buckypaper. Large quantities can be manufactured in this manner in a cost-effective manner.

The measuring cell has openings, which are provided with a membrane permeable to the analyte and otherwise seal the measuring cell towards the outside. The electrochemical cell contains at least one measuring electrode and a counterelectrode, which may be arranged coplanarly, plane-parallel or radially in relation to one another and are each flat. In addition to the counterelectrode, a reference electrode may be present. A separator, which maintains the electrodes at spaced locations from one another and is impregnated with the electrolyte, is located between the plane parallel electrodes.

The electrode materials used for the reference electrode may be precious metals such as platinum or iridium, carbon nanotubes or an electrode of a second type, which consists of a metal that is at equilibrium with a poorly soluble metal salt.

The counterelectrode preferably consists of a precious metal, e.g., gold, platinum or iridium/iridium oxide or carbon nanotubes or a consumable electrode consisting of silver, lead or nickel.

Alkali or alkaline earth metal halides, preferably chlorides or bromides, which are preferably hygroscopic in an aqueous solution, are used as supporting electrolytes.

The pH value of the electrolyte is preferably stabilized with a buffer. Especially advantageous formulas are an aqueous LiCl solution or an aqueous LiCl solution with saturated calcium carbonate CaCO₃ as a solid solute, as well as an aqueous LiBr solution, or an aqueous LiBr solution with saturated calcium carbonate CaCO₃ as solid solute. Calcium carbonate is used as a pH stabilizer for the electrolyte solution. Other alkaline earth carbonates, such as magnesium carbonate or barium carbonate, which are also expressly covered by the scope of protection, are also suitable for use as pH stabilizers as an alternative.

An advantageous use of an electrochemical gas sensor, which has a measuring electrode consisting of carbon nanotubes (CNT) and a counterelectrode in an electrolyte, which contains lithium chloride or lithium bromide in aqueous solution, is in the detection of ozone or nitrogen dioxide in a gas sample. Preferred materials for the measuring electrode are multiwalled carbon nanotubes (MW CNT). Especially preferred electrolytes are, besides the aqueous LiCl solution, an aqueous LiCl solution with saturated CaCO₃ as a solid solute or an aqueous LiBr solution with saturated CaCO₃ as a solid solute.

An exemplary embodiment of the gas sensor according to the present invention is shown in the figures and will be explained in more detail below. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a longitudinal sectional view of an electrochemical gas sensor; and

FIG. 2 is a graph showing the effect of the relative humidity on the measured signal.

### DESCRIPTION OF THE PREFERRED EMBODIMENTS

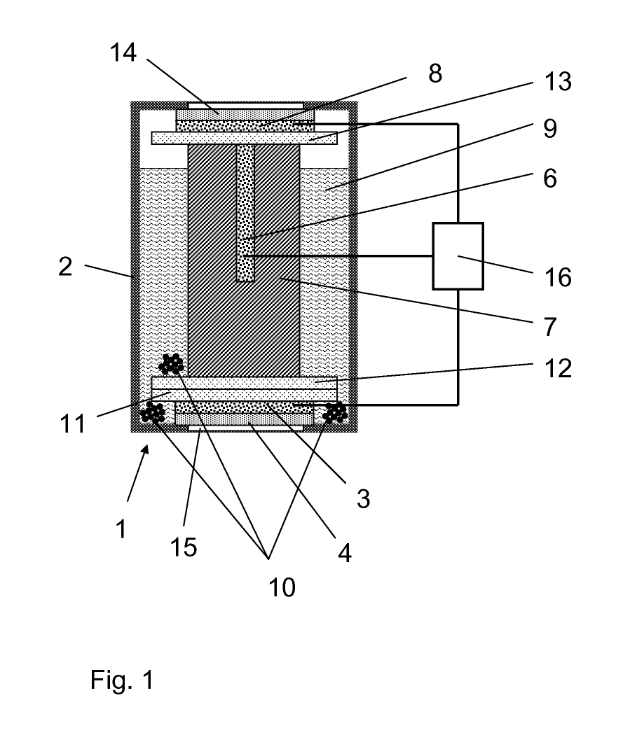

Referring to the drawings in particular, FIG. 1 shows a gas sensor 1, in which a measuring electrode 3 consisting of carbon nanotubes (CNT) on a diffusion membrane 4. A reference electrode 6 in a wick 7 and a counterelectrode 8 are arranged in a sensor housing 2. The interior of the sensor housing 2 is filled with an electrolyte 9, and a pH stabilizer 10 is also present additionally as a solid solute. The electrodes 3, 6, 8 are maintained at a fixed distance from each other by means of liquid-permeable nonwovens 11, 12, 13. The gas enters through an opening 15 in the sensor housing 2. The gas sensor 1 is connected to a potentiostat 16 in the known manner. The preferred potential range for the potentiostat 16 is −300 mV to 0 mV, and the especially preferred bias voltage is −100 mV in case of the use of a reference electrode made of precious metal or carbon nanotubes.

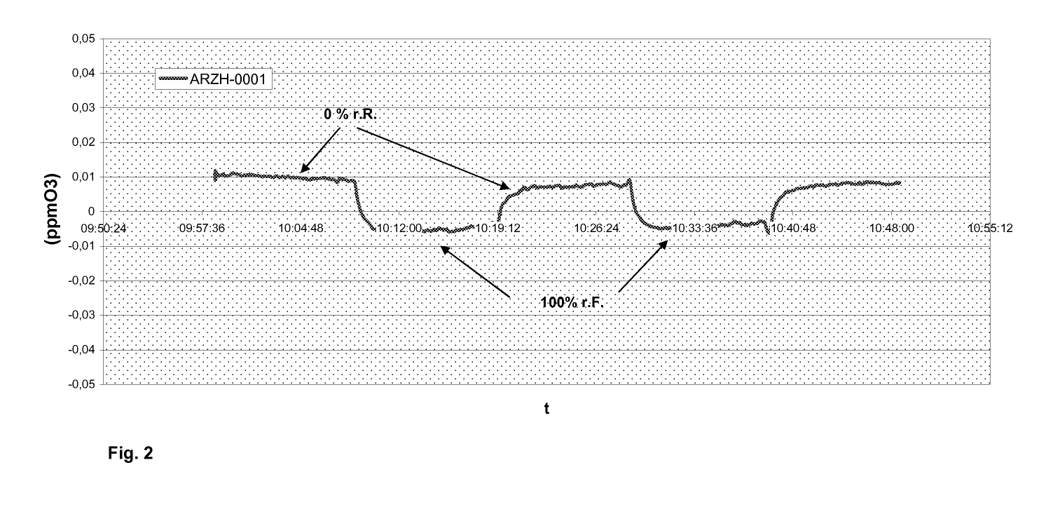

FIG. 2 illustrates the effect of the relative humidity on the measured signal of the gas sensor 1 for determining ozone in a gas sample. The time t is plotted on the abscissa and the measured signal in ppm O₃ on the ordinate. The gas was admitted alternatingly with 0% relative humidity and 100% relative humidity. The range of variation of the measured signal is in such case about 0.01 ppm. The change in the measured signal is thus smaller by a factor of 10 than the limit value of 0.1 ppm.

While specific embodiments of the invention have been described in detail to illustrate the application of the principles of the invention, it will be understood that the invention may be embodied otherwise without departing from such principles.

What is claimed is:

1. An electrochemical gas sensor for detecting ozone or nitrogen dioxide in a gas sample, the electrochemical gas sensor comprising:
a measuring electrode containing carbon nanotubes (CNT);
an electrolyte solution which has lithium chloride or lithium bromide; and
a counterelectrode, the measuring electrode and the counterelectrode being in contact with the electrolyte solution.

2. An electrochemical gas sensor in accordance with claim 1, wherein the carbon nanotubes are located on a porous carrier, a nonwoven material or a diffusion membrane.

3. An electrochemical gas sensor in accordance with claim 1, wherein the carbon nanotubes are fitted together by self-aggregation or by means of a binder.

4. An electrochemical gas sensor in accordance with claim 3, wherein the binder is PTFE.

5. An electrochemical gas sensor in accordance with claim 1, wherein the carbon nanotubes are present as a film in the form of a so-called buckypaper.

6. An electrochemical gas sensor in accordance with claim 1, wherein the carbon nanotubes are present in the form of single-walled or multiwalled carbon nanotubes and a layer thickness of the electrode material is between 0.5 μm and 500 μm.

7. An electrochemical gas sensor in accordance with claim 1, wherein the counterelectrode consists of a precious metal, or iridium or carbon nanotubes or silver, lead or nickel.

8. An electrochemical gas sensor in accordance with claim 1, further comprising a reference electrode formed of one or more of a precious metal, carbon nanotubes or an electrode of a second type, wherein the electrode of the second type is a metal, which is at equilibrium with a poorly soluble metal salt.

9. An electrochemical gas sensor in accordance with claim 1, wherein the electrolyte solution is present as an aqueous electrolyte.

10. An electrochemical gas sensor in accordance with claim 1, wherein the electrolyte is an aqueous LiCl solution or an aqueous LiCl solution with saturated CaCO₃ as a solid solute or an aqueous LiBr solution with saturated CaCO₃ as a solid solute.

11. An electrochemical gas sensor in accordance with claim 1, wherein the carbon nanotubes are present in the form of single-walled or multiwalled carbon nanotubes and a layer thickness of the electrode material is between 10 μm and 50 μm.

12. An electrochemical gas sensor in accordance with claim 1, wherein the counterelectrode consists of one or more of gold, platinum or iridium or carbon nanotubes or silver, lead or nickel.

13. A method of electrochemical gas sensing, the method comprising the steps of:
providing an electrochemical gas sensor with a measuring electrode formed of carbon nanotubes (CNT) and an electrolyte, which contains lithium chloride or lithium bromide in an aqueous solution and a counterelectrode, the measuring electrode and the counterelectrode being in contact with the electrolyte; and
detecting ozone or nitrogen dioxide with the electrochemical gas sensor.

14. A method in accordance with claim 13, wherein the carbon nanotubes are present as multiwalled carbon nanotubes.

15. A method in accordance with claim 13, wherein an aqueous LiCl solution with saturated CaCO₃ as a solid solute or an aqueous LiBr solution with saturated CaCO₃ as a solid solute is present as the electrolyte.

16. A method in accordance with claim 13, wherein the carbon nanotubes are located on a porous carrier, a nonwoven material or a diffusion membrane.

17. A method in accordance with claim 13, wherein the carbon nanotubes are fitted together by self-aggregation or by means of a binder.

18. A method in accordance with claim 17, wherein the binder is PTFE.

19. A method in accordance with claim 13, wherein the carbon nanotubes are present as a film in the form of a so-called buckypaper.

20. A method in accordance with claim 13, wherein the carbon nanotubes are present in the form of single-walled or multiwalled carbon nanotubes and a layer thickness of the electrode material is between 0.5 μm and 500 μm.
